(19) United States
(12) Patent Application Publication
(10) Pub. No.: US 2024/0354775 A1
(43) Pub. Date: Oct. 24, 2024

(54) EMISSION BASED ENERGY USAGE MANAGEMENT FOR ELECTRICAL POWER SYSTEMS

(71) Applicant: Voltus, Inc., San Francisco, CA (US)

(72) Inventors: Dana Guernsey, Arlington, MA (US); Neil Lakin, Glendale, CA (US)

(21) Appl. No.: 18/644,614

(22) Filed: Apr. 24, 2024

Related U.S. Application Data
(60) Provisional application No. 63/497,955, filed on Apr. 24, 2023.

(51) Int. Cl. G06Q 30/018

(52) U.S. Cl. CPC G06Q 30/018

(57) ABSTRACT

A method for energy usage management for an electrical power system includes determining an extent of local energy emission intensity of the electrical power system, calculating a dispatching parameter for potential energy emission geographical sites, determining a reduction in energy emission for the geographical sites over a temporal period based on the dispatching parameter, and generating an energy emission impact report.

### CROSS-REFERENCE OF RELATED APPLICATION

This application claims the benefit of U.S. Provisional Application No. 63/497,955, filed on Apr. 24, 2023, which is incorporated herein in its entirety.

### TECHNICAL FIELD

The present disclosure generally relates to energy usage management for electrical power systems such as electrical grids. More specifically, the present disclosure is related to a system that connects distributed energy resources to emission intensity signals and manages energy usage reductions during high intensity energy (e.g., greenhouse gas) emissions. The emission intensity signals may be generated externally to the electrical power systems and may indicate periods of high carbon emissions.

### BACKGROUND

Conventional energy management systems can be inefficient in terms of dispatching the distributed energy resources. Such systems may not account for the intensity of energy emissions in terms of geographically localized intensity levels. Such energy emissions can be greenhouse gas (GHG) emissions such as methane emissions, carbon dioxide emissions, and/or the like. Rather, convention systems can perform energy resource dispatching based on grid reliability, cost, and other signals. Thus, such electrical power systems may incur an undesirable quantity of GHG emissions.

### SUMMARY

Some embodiments of the present disclosure provide a method for energy usage management for an electrical power system. The method includes determining an extent of local energy emission intensity of the electrical power system, calculating a dispatching parameter for potential energy emission geographical sites, determining a reduction in energy emission for the geographical sites over a temporal period based on the dispatching parameter, and generating an energy emission impact report.

Some embodiments of the present disclosure provide a non-transitory computer-readable medium storing a program for energy usage management for an electrical power system. The program, when executed by a computer, configures the computer to determine an extent of local energy emission intensity of the electrical power system, calculate a dispatching parameter for potential energy emission geographical sites, determine a reduction in energy emission for the geographical sites over a temporal period based on the dispatching parameter, and generate an energy emission impact report.

Some embodiments of the present disclosure provide a system for energy usage management for an electrical power system. The system comprises a processor and a non-transitory computer readable medium storing a set of instructions, which when executed by the processor, configure the processor to determine an extent of local energy emission intensity of the electrical power system, calculate a dispatching parameter for potential energy emission geographical sites, determine a reduction in energy emission for the geographical sites over a temporal period based on the dispatching parameter, and generate an energy emission impact report.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture to provide a system for energy usage management, according to some embodiments.

FIG. 2 illustrates a client device and a server for use in the network architecture of FIG. 1, according to some embodiments.

FIG. 3 illustrates a computer system with which aspects of the subject technology can be implemented, according to some embodiments.

FIG. 4 illustrates a process for energy usage management for an electrical power system, according to some embodiments.

FIG. 5 is a block diagram illustrating an exemplary computer system with which aspects of the present disclosure can be implemented.

FIG. 6 shows an example of tracking marginal CO2 emission intensity for electrical power systems at multiple geographic sites, according to some embodiments.

FIG. 7 shows an example of a CO2 impact report, according to some embodiments.

FIGS. 8A and 8B show examples of customizable details and parameters for a carbon response program, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

In energy usage systems, the management of distributed energy resources relative to greenhouse gas (GHG) emissions and energy dispatching on an electrical grid in a carbon response program may advantageously result in reduced GHG/carbon emissions. The carbon response program may aggregate carbon response resources to create virtual power plants (VPPs) that may advantageously be used to reduce carbon emissions. Conventional energy usage management systems may be inefficient and result in wasteful or undesirable emissions. The subject disclosure addresses computational efficiency of an energy management computer system by dispatching distributed energy resources (DER) based on tracking localized emissions intensity on the electrical grid. The disclosed energy management computer system addresses this computational efficiency problem specifically arising in the realm of computer technology by providing a solution also rooted in computer technology. The subject disclosure provides a solution that improves the efficiency and reduce latency of energy resource management computing networks, such as via faster data transmissions based on telemetry devices and/or energy-related data that enables a cloud-based computing system to control remote equipment and systems for intelligent dispatching that realizes reductions in undesirable GHG energy emissions. As used herein, DER can refer to electrical generation and storage by electrical grid connected or proximate devices, such as rooftop solar panels and battery storage.

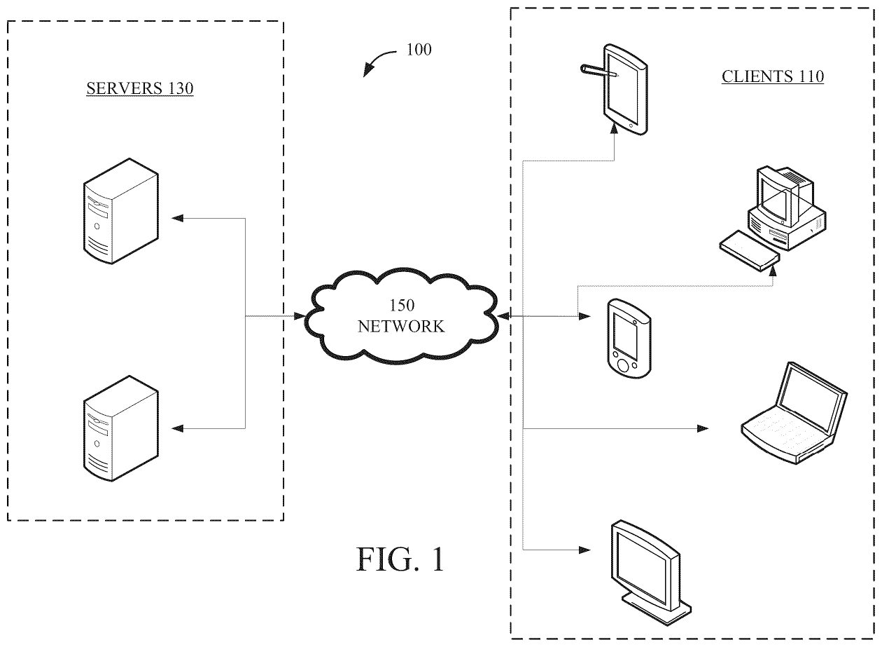

FIG. 1 is a block diagram of a device operating environment with which aspects of the present disclosure can be implemented. FIG. 1 illustrates a network architecture 100 to provide a system for energy usage management, according to some embodiments. For example, the system may be a computing platform (e.g., energy resource management computing platform, carbon response computing platform), including but not limited to distributed energy resource and other energy usage reduction programs and algorithms, including demand side management and dispatch. As used herein, carbon impact amount refers to reduction in energy load of a user that is not offset with user energy production or consumption increases or other leakage. As used herein, carbon impact amount refers to avoided tonnes of carbon dioxide associated with carbon response reductions. The users may access the provided energy usage reduction programs and algorithms via client devices 110.

For providing the programs and algorithms, servers 130 can perform energy dispatching operations such as from DER, which can include DER supply and demand response controlling (e.g., reductions in energy usage/emission reductions by users during moderate intensity and high intensity GHG emissions on a corresponding electrical grid). The servers 130 may implement an application programming interface (API), such as a grid intensity API to determine optimal hours of impact for implementing energy reductions (e.g., carbon response reductions). The servers 130 may also send automated DER signals, Carbon Response Reduction dispatch notifications to key site contacts, and/or confirmation tracking to the client devices 110. The servers 130 may also send, receive, and analyze utility interval data from a telemetry device (e.g., could be part of the client devices 110), such as in real-time. The servers 130 can also report monthly, energy consumption and reduction data that is reasonably available, including baseline data used to calculate such reductions, with at least hourly granularity, the actual performance metrics, energy reductions due to carbon response reductions, the carbon impact amount, and the applicable megawatt hours (MWh). The servers 130 may generate and/or send a GHG or carbon dioxide emission impact report for the client devices 110. The servers 130 may comprise memory to host and manage data uploaded to the carbon response computing platform. The computing devices of the servers 130 can comprise processors to execute various algorithms and/or modules for user energy load/carbon response reductions, energy dispatching to physical sites, and energy resource/usage management.

The client devices 110 may be any one of a mobile device, a laptop, a desktop, a tablet (e.g., palm or pad) device, a television, a display device, telemetry device for energy/DER dispatch and/or the like. The client devices 110 can on user premises, such as being located in a physical space. The client devices 110 can correspond to energy resource users that are capable of reducing energy usage and receiving DER, such as via site dispatching performed by the servers 130. The client devices 110 can be used to display, manage, analyze, send, and/or receive energy resource related data, such as energy consumption data, utility interval data, GHG impact data, localized emission intensity data, GHG emission reduction data, operational data, and/or the like. Impact data can indicate a quantity of metric tons of undesirable carbon dioxide emissions that are avoided, for example. The client devices 110 can be in communication with servers 130 via a network 150 for access to the carbon response computing platform.

Each user of the client devices 110 can access an energy management interface, such as for tracking dispatching, emissions information, reductions in scope 1, 2, or 3 GHG emissions, and/or the like. The interface may be hosted on a network such as the network 150, which may be the Internet. In this way, the interface may be accessed in an online or offline manner via the network 150 such as via an identifier (e.g., web address, website, uniform resource location (URL)) of a website/webpage on the World Wide Web (WWW) accessible via the Internet. The carbon response computing platform may include a network architecture by which user devices operated by various users or customers may access the carbon response computing platform. The network architecture includes one or more client devices 110 and one or more servers 130 which are communicatively coupled through the network 150. The network 150 may include a wired network (e.g., via fiber optic or copper wire, telephone lines, and the like) or wireless network (e.g., a cellular network, radio-frequency (RF) network, Wi-Fi, Bluetooth, and the like). Multiple client devices 110 may have access to the carbon response platform hosted by the servers 130 via an online or offline connection, such as a wireless connection, wired connection, ad hoc connection, mobile connection, satellite connection, and/or the like. Each of the servers 130 may be a computing device such as a workstation, including one or more desktop computers or panels mounted on racks, and the like. The panels may include processing boards and also switchboards, routers, and other network devices.

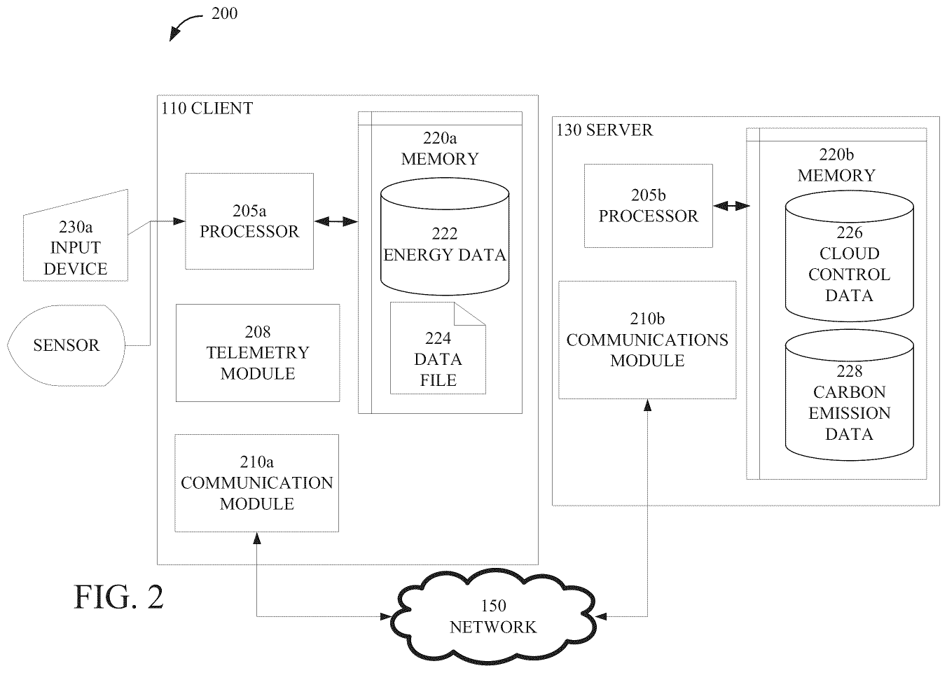

FIG. 2 illustrates a computing network 200 having a client device (of one or more client devices) 110 and a server (of one or more servers) 130 for use in the network architecture of FIG. 1, according to some embodiments. For example, FIG. 2 may be an example of an energy resource management computing platform for providing distributed energy resource and other energy usage reduction functions, according to certain aspects of the present disclosure. The client device 110 and server 130 depicted in FIGS. 1-2 may each include a processor 205a-205b, a communications module 210a-210b, and memory 220a-220b, respectively. Each of the one or more client devices 110 and the one or more servers 130 may access each other and other devices in the network 150 via corresponding communications modules 210a-210b. The communications modules 210a-210b may each include radio hardware and software such as RF antennas, analog circuitry, digital to analog conversion circuits, digital signal processing circuitry, and/or the like.

Generally, the client device 110 and the server 130 comprise computing devices including at least: the memory 220a-220b storing instructions and processors 205a-205b configured to execute the instructions to perform, at least partially, one or more steps as described in methods disclosed herein. For example, the memory 220a of the client device 110 may be used to gain access to a browser, application (e.g., for localized emissions intensity tracking on an applicable electrical grid), or device component corresponding to the energy resource management computing platform hosted by the server 130. The client device 110 may be used by users of the energy resource management computing platform. For example, the client device 110 may be coupled to at least one input device 230a and output device (not shown). The input device 230a can include a mouse, keyboard, a pointer, a stylus, a touchscreen display, microphone, voice recognition software, graphical user interface (GUI), and/or the like. The output device can include a display (e.g., the same touchscreen display as the input device), a speaker, an alarm, and the like.

The client device 110 can include a telemetry module 208 for providing telemetry. For example, the telemetry module 208 can be a telemetry device that automatically acquires and communicate energy-related data from users of the energy resource management computing platform via a cloud-based application and can receive instructions to control remote equipment and systems. These telemetry functions can be supported via a microphone, camera, location component and/or the like of the client device 110. As an example, the telemetry module 208 can be in communication with the processor 205a and memory 220a to access, update, send, receive, gather, etc. energy data. The telemetry module 208 may also implement remote distributed generation control and direct load management at user energy usage sites. In this way, the telemetry module 208 may facilitate development of a custom curtailment plan for electric load reduction, not offset with user energy consumption increases, that avoids or reduces emissions of GHG and carbon dioxide to the atmosphere (e.g., Earth's atmosphere).

As an example, users may receive such energy usage/resource management related information or analysis via the user interface of the client device 110 such as in the form of a data overlay. The database 222 may store energy data in the memory 220a for this purpose. For example, the energy data can be utility data, electrical meter data, and/or the like. The energy data can be send and receive between the client device 110 and the server 130 via the network 150. The processor 205a of the client device 110 may be used to operate the client device 110, such as to execute applications and functions thereof rendered on the client device 110. The processor 205a can perform some or all of the energy data analysis, dispatching management, emission intensity tracking, energy usage measurement, and/or the like performed by the server 130, which may be located locally or remotely to the client device 110. The applications can include an application corresponding to the example energy resource management computing platform. In this way, the user can use the input device 230a (e.g., send user inputs) to cause the processor 205a to execute machine executable instructions for rendering a graphical user interface constituting the data overlay as well as for collecting, analyzing, and otherwise manipulating/performing data and operations relevant to an energy usage management or carbon response function provided by the server 130. The memory 220a may also contain a data file 224 usable for executing the application of the energy resource management computing platform. The data file 224 can be used to cache data or accessible by the application for performing various functions.

The memory 220b of the server 130 can also store energy usage and management information (e.g., emissions tracking and reduction information such as for Scope 1, 2, and 3 emissions), such as in the databases 226, 228. The databases 226, 228 can store cloud control and carbon/GHG emission data that can be accessed by the processor 205b to send information or analysis to the processor 205a. Such operations by the processor 205b can be triggered by conditions such as related to utility interval data from the telemetry module 208. The cloud control data can be related to a cloud computing based application of the server 130 that collects and provides access to energy data, such as usage, DER capacity, dispatching, utility data, and/or the like, which can be stored in the database 226. Emissions intensity and reduction data can be stored in the database 228.

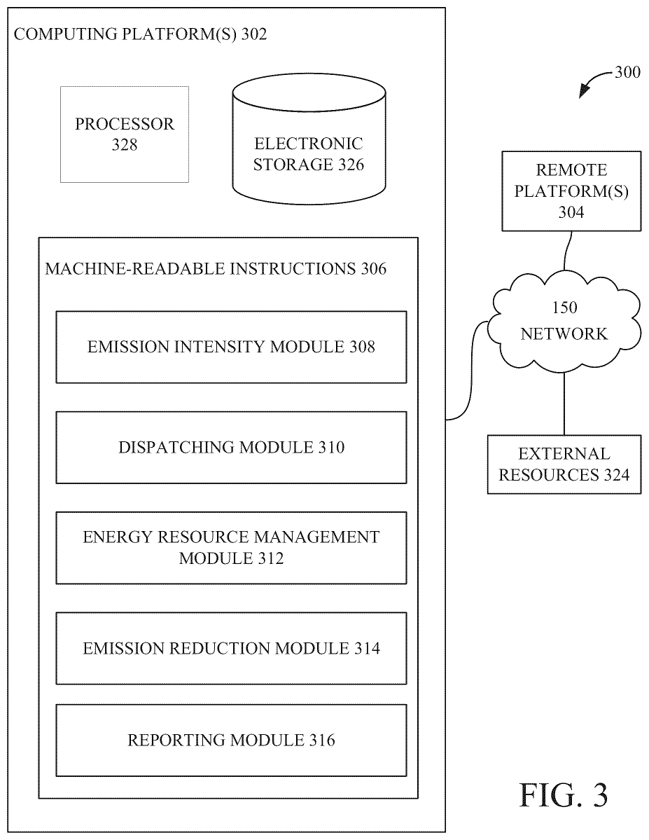

FIG. 3 is a block diagram illustrating an example computer system 300 (e.g., representing both client and server) with which aspects of the subject technology can be implemented. The system 300 may be configured for providing distributed energy resource and other energy usage reduction via an energy resource management computing platform, according to certain aspects of the disclosure. In some implementations, the system 300 may include one or more computing platforms 302. The computing platform 302 can correspond to a server component of a content computing platform, which can be similar to or the same as the servers 130 of FIG. 2. As an example, the computing platform 302 can comprise processor 328 that may be similar or the same as processor 205b and comprise electronic storage 326 that may include databases such as databases 222, 226, 228. The computing platform 302 can be configured to store, retrieve, determine, and/or analyze energy usage and energy emission intensity data for providing demand side management and dispatch functions. For example, the computing platform 302 may be configured to execute algorithms for DER dispatching to user sites that require energy. In this way, GHG emissions can be reduced and offset, at least in part.

The computing platform 302 may be configured to communicate with one or more remote platforms 304 according to a client/server architecture, a peer-to-peer architecture, and/or other architectures. Remote platform 3024 may be configured to communicate with other remote platforms via computing platform 302 and/or according to a client/server architecture, a peer-to-peer architecture, and/or other architectures. Users may access system 300 via remote platform 3024. In this way, the remote platform 3024 can be configured to cause output of a customized carbon response application of the energy resource management computing platform on client device(s) of the remote platform 3024, such as client devices 110 of FIGS. 1-2. The carbon response application can be customized according to operational needs. The carbon response application may be used to control and apply energy reductions during times of moderate or high intensity carbon emissions on the electric grid. As an example, the remote platform 3024 can access the application for receiving updates on localized emission intensity on the electrical grid, DER dispatch, and emission reduction measurement. The computing platform 302, external resources 324, and remote platform 3024 may be in communication and/or mutually accessible via the network 150.

The computing platform 302 may be configured by machine-readable instructions 306. The machine-readable instructions 306 may include one or more instruction modules. The instruction modules may include computer program modules. The instruction modules may include one or more of emission intensity module 308, dispatching module 310, energy resource management module 312, emission reduction module 314, reporting module 316, and/or other instruction modules.

The emission intensity module 308 can be configured to track localized emission intensity on the electrical grid for energy demand side management and dispatch functions provided to the remote platform 3024. For example, the emission intensity module 308 can determine temporal periods in which moderate to high intensity GHG or carbon emissions occur. The emission intensity module 308 can implement a grid intensity application programming interface (API).

The dispatching module 310 can be configured to determine optimal times to dispatch DER resources, such as to physical sites (i.e., physical places that have energy usage needs) of users of the remote platform 3024. The dispatching can be performed by the dispatching module 310 at optimal hours of impact, which can be determined via the grid intensity API of the emission intensity module 308. The dispatching module 310 can also generate and send automated DER signals, carbon response reduction dispatch notifications to key site contacts, confirmation tracking, and alerts to ensure successful energy load curtailment for/to the users of the remote platform 3024 (and the energy resource management computing platform). A real time telemetry device may be installed at the physical sites of the users in order to support dispatching of DER. The dispatching module 310 may determine a user contracted energy load curtailment performance during carbon response reduction dispatches as well as baseline data.

The energy resource management module 312 can be configured to manage energy allocation, usage, and tracking in order to provide GHG emission reductions, offsets, and/or allowances to users of the remote platform 3024. The energy resource management module 312 and the dispatching module 310 may intelligently dispatch energy resources to reduce GHG and carbon dioxide impact based on the measured intension of electrical grid GHG emissions.

The emission reduction module 314 may be configured to measure GHG emission reduction that beneficially result from participation in the demand response or DER program provided by the energy resource management computing platform.

The reporting module 316 can be configured to generate reports that show or otherwise indicate GHG/carbon dioxide emission impact for each user of the energy resource management computing platform. The reports generated by the reporting module 316 may indicate equivalent energy emissions that are avoided, such as being equivalent to miles driven by a gas vehicle, pounds of coal burned, gallons of gasoline consumed, barrels of oil consumed, and/or the like. The reports generated by the reporting module 316 may indicate an equivalent quantity of sequestered GHG/carbon, such as a quantity of tree seedings grown or acres of forests over a period of time. The reports generated by the reporting module 316 may indicate load reduction and net avoided emission on a per time period basis.

In some implementations, the computing platform 302, the remote platform 3024, and/or the external resources 324 may be operatively linked via one or more electronic communication links. For example, such electronic communication links may be established, at least in part, via the network 150 such as the Internet and/or other networks. It will be appreciated that this is not intended to be limiting, and that the scope of this disclosure includes implementations in which the computing platform 302, the remote platform 3024, and/or the external resources 324 may be operatively linked via some other communication media.

A given remote platform 304 may include one or more processors 328 configured to execute computer program modules. The computer program modules may be configured to enable an expert or user associated with the given remote platform 304 to interface with system 300 and/or external resources 324, and/or provide other functionality attributed herein to remote platform 3024. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms. The external resources 324 may include sources of information outside of the system 300, external entities participating with the system 300, and/or other resources. In some implementations, some or all of the functionality attributed herein to the external resources 324 may be provided by resources included in system 300.

The computing platform 302 may include the electronic storage 326, the processor 328, and/or other components. The computing platform 302 may include communication lines, or ports to enable the exchange of information with a network and/or other computing platforms. Illustration of the computing platform 302 in FIG. 3 is not intended to be limiting. The computing platform 302 may include a plurality of hardware, software, and/or firmware components operating together to provide the functionality attributed herein to the computing platform 302. For example, the computing platform 302 may be implemented by a cloud of computing platforms operating together as the computing platform 302.

The electronic storage 326 may comprise non-transitory storage media that electronically stores information. The electronic storage media of the electronic storage 326 may include one or both of system storage that is provided integrally (i.e., substantially non-removable) with computing platform 302 and/or removable storage that is removably connectable to computing platform 302 via, for example, a port (e.g., a USB port, a firewire port, etc.) or a drive (e.g., a disk drive, etc.). The electronic storage 326 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 326 may include one or more virtual storage resources (e.g., cloud storage, a virtual private network, and/or other virtual storage resources). The electronic storage 326 may store software algorithms, information determined by the processor 328, information received from computing platform 302, information received from the remote platform 3024, and/or other information that enables the computing platform 302 to function as described herein.

The processor 328 may be configured to provide information processing capabilities in the computing platform 302. As such, the processor 328 may include one or more of a digital processor, an analog processor, a digital circuit designed to process information, an analog circuit designed to process information, a state machine, and/or other mechanisms for electronically processing information. Although the processor 328 is shown in FIG. 3 as a single entity, this is for illustrative purposes only. In some implementations, the processor 328 may include a plurality of processing units. These processing units may be physically located within the same device, or the processor 328 may represent processing functionality of a plurality of devices operating in coordination. Processor 328 may be configured to execute modules 308, 310, 312, 314, 316, and/or other modules. Processor 328 may be configured to execute modules 308, 310, 312, 314, 316, and/or other modules by software; hardware; firmware; some combination of software, hardware, and/or firmware; and/or other mechanisms for configuring processing capabilities on the processor 328. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although the modules 308, 310, 312, 314, and/or 316 are illustrated in FIG. 3 as being implemented within a single processing unit, in implementations in which the processor 328 includes multiple processing units, one or more of the modules 308, 310, 312, 314, and/or 316 may be implemented remotely from the other modules. The description of the functionality provided by the different modules 308, 310, 312, 314, and/or 316 described herein is for illustrative purposes, and is not intended to be limiting, as any of the modules 308, 310, 312, 314, and/or 316 may provide more or less functionality than is described. For example, one or more of the modules 308, 310, 312, 314, and/or 316 may be eliminated, and some or all of its functionality may be provided by other ones of the modules 308, 310, 312, 314, and/or 316. As another example, the processor 328 may be configured to execute one or more additional modules that may perform some or all of the functionality attributed below to one of the modules 308, 310, 312, 314, and/or 316.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

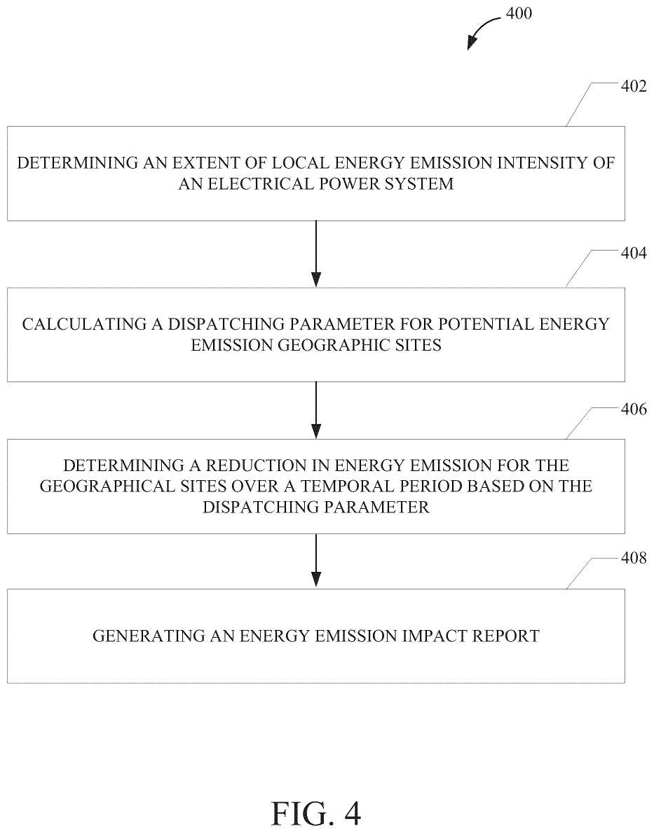

FIG. 4 illustrates a process 400 for energy usage management for an electrical power system, according to some embodiments. The process 400 may be performed at least partially by any one of the server, client, platform, and/or other components illustrated in FIGS. 1-3. For example, at least some of the steps in process 400 may be performed by one component in a system including a client device running code for a browser and an application to access the server or the database (e.g., the servers 130 of FIGS. 1-2, the computing platform 302 of FIG. 3). Accordingly, at least some of the steps in process 400 may be performed by a processor executing commands stored in a memory of the server or of the client device, or accessible by the server or by the client device. Further, in some embodiments, at least some of the steps in process 400 may be performed overlapping in time, almost simultaneously, or in a different order from the order illustrated in process 400. Moreover, a method consistent with some embodiments disclosed herein may include at least one, but not all, of the steps in process 400.

Step 402 includes determining an extent of local energy emission intensity of the electrical power system.

Step 404 includes calculating a dispatching parameter for potential energy emission geographical sites. For example, calculating the dispatching parameter involves determining time periods in which no energy is used.

Step 406 includes determining a reduction in energy emission for the geographical sites over a temporal period based on the dispatching parameter. For example, the energy emission is greenhouse gas or carbon emissions.

Step 408 includes generating an energy emission impact report. For example, generating an energy emission impact report involves determining an offset parameter for designated emissions.

The process 400 may further include changing the dispatching parameter based on seasonality. The process 400 may further include determining a subset of the geographical sites with the highest energy emissions.

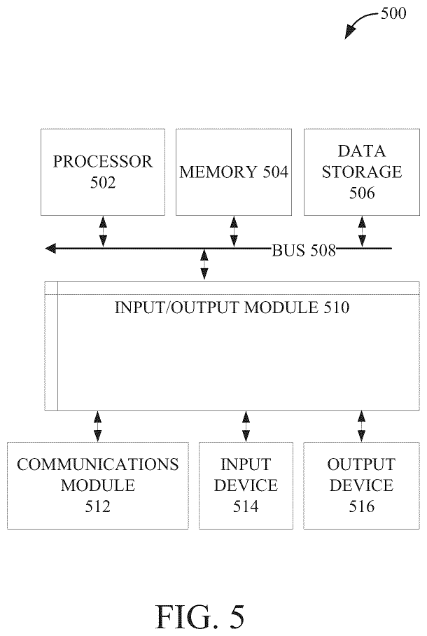

FIG. 5 is a block diagram illustrating an exemplary computer system 500 with which aspects of the present disclosure can be implemented. For example, the computer system 500 may be configured to determine moderate and high intensity GHG emissions on an electric grid as well as manage DER, dispatching, carbon response reduction, and energy usage data. In certain aspects, the computer system 500 may be implemented using hardware or a combination of software and hardware, either in a dedicated server, integrated into another entity, or distributed across multiple entities. For example, the client devices 110 and servers 130 of FIGS. 1-2 can include one or more of the computer system 500.

The computer system 500 includes a bus 508 or other communication mechanism for communicating information, and a processor 502 (e.g., a CPU, GPU, etc.) coupled with bus 508 for processing information. By way of example, the computer system 500 may be implemented with one or more processors 502. The processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 500 can include, in addition to hardware, code that creates an execution environment for the computer program in question, for example, code that constitutes processor firmware, a protocol stack, a database management system, an operating system, or a combination of one or more of them stored in an included memory 504 (e.g., memory 220a-220b), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to the bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as a LCD (liquid crystal display) monitor, for displaying information to the user.

According to one aspect of the present disclosure, the computing platforms or systems described herein can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

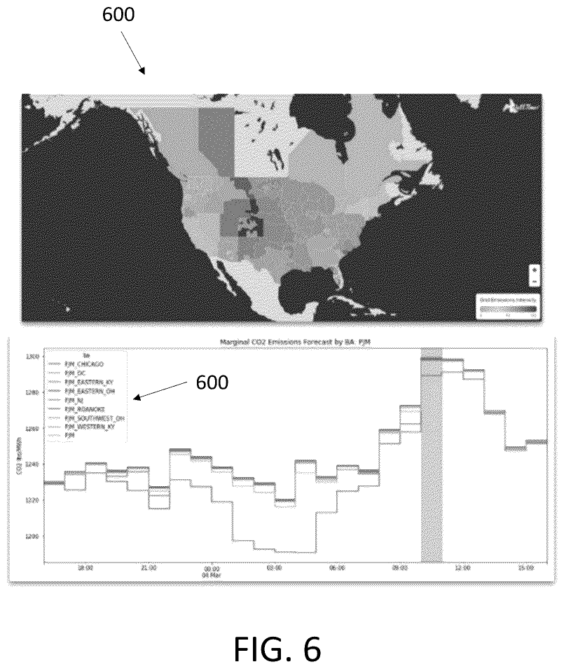

FIG. 6 shows an example 600 of tracking marginal CO2 emission intensity for electrical power systems at multiple geographic sites 610, according to some embodiments. In this example, the emissions are measured in pounds per megawatt hour (lbs./MWh), measured over a temporal period of 24 hours. The emissions may be used, for example, to calculate a dispatching parameter that can be used at least to determine energy reductions for the geographical sites 610 over the temporal period, and to generate reports (e.g. an energy emission impact report, such as report 700 described below).

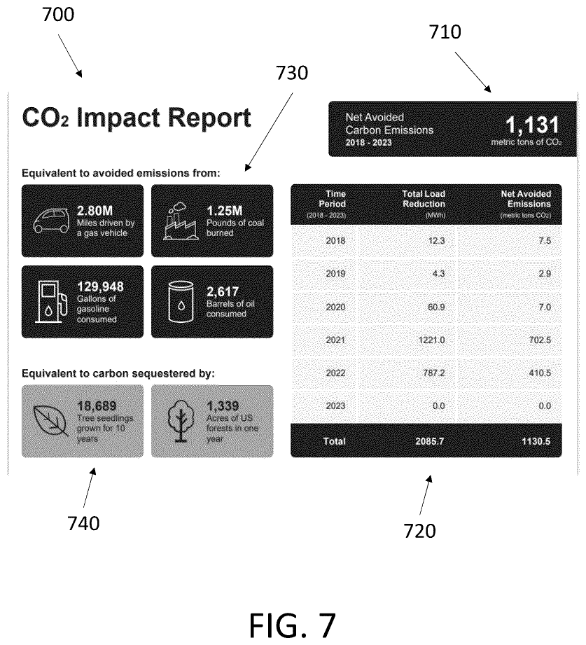

FIG. 7 shows an example of a CO2 impact report 700, according to some embodiments. The report may include a net amount 710 of avoided carbon emissions for a period of time, e.g., in this example, measured in metric tons of CO2, over a 5 year period. The report may also include measurements 720 of total load reduction (measured in MWh) and net avoided emissions for sub-periods of time (in this example, individual years in the 5 year period). The report may also include estimates 730 of equivalent emissions from other pollution sources and/or estimates 740 of carbon sequestered by different environmental sources. Pollution sources may include, but are not limited to, miles driven by a gas vehicle, pounds of oil burned, gallons of gasoline consumed, barrels of oil consumed, and the like. Environmental sources may include, but are not limited to, tree seedlings grown for a number of years (e.g., 10 years), acres of forests sequestering carbon for one year, and the like.

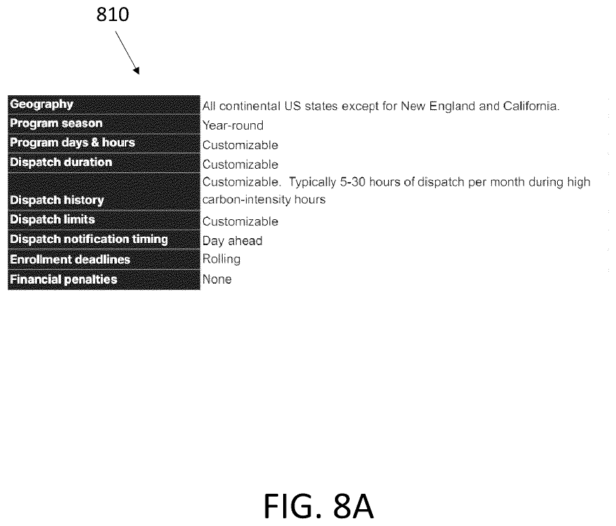

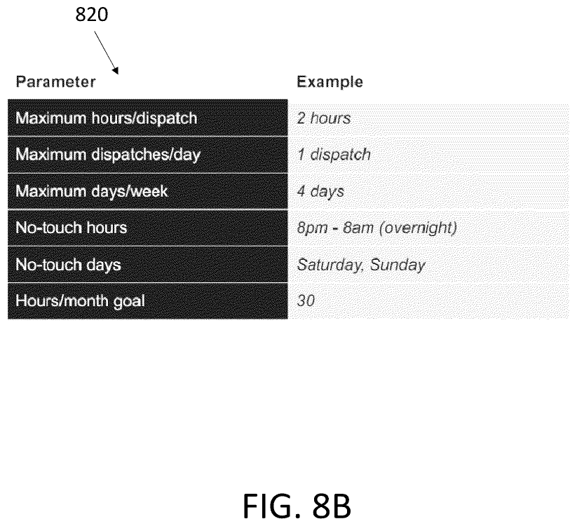

FIG. 8A shows an example of customizable details 810 for a carbon response program that in some embodiments, may be used to calculate payments for energy reductions during times of high intensity carbon emissions on the electric grid. Payments may be made for dispatching more hours as well as dispatching during “dirtier” grid emissions hours, to improve CO2 impact. The details 810 may include, but are not limited to, geography, program season, program days and hours, dispatch duration, dispatch history, dispatch limits, dispatch notification timing, enrollment deadlines, and financial penalties. Some or all of the details may be customizable.

FIG. 8B shows an example of parameters 820 for a carbon response program that in some embodiments, may be used to calculate a dispatching parameter that can be used at least to determine energy reductions for geographical sites over a temporal period, and generate reports (e.g. an energy emission impact report). The parameters may include, but are not limited to, maximum hours per dispatch (e.g., 2 hours), maximum dispatches per day (e.g., 1 dispatch), maximum days per week (e.g., 4 days), no-touch hours (e.g., 8 pm to 8 am overnight), no-touch days (e.g., Saturday and Sunday), an hours per month goal (e.g. 30 hours), and the like.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure. Relational terms such as first and second and the like may be used to distinguish one entity or action from another without necessarily requiring or implying any actual such relationship or order between such entities or actions.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for energy usage management for an electrical power system, comprising:
determining an extent of local energy emission intensity of the electrical power system;
calculating a dispatching parameter for potential energy emission geographical sites;
determining a reduction in energy emission for the geographical sites over a temporal period based on the dispatching parameter; and
generating an energy emission impact report.

2. The method of claim 1, wherein the energy emission is greenhouse gas or carbon emissions.

3. The method of claim 1, wherein calculating the dispatching parameter comprises determining time periods in which no energy is used.

4. The method of claim 1, wherein generating an energy emission impact report comprises determining an offset parameter for designated emissions.

5. The method of claim 1, further comprising changing the dispatching parameter based on seasonality.

6. The method of claim 1, further comprising determining a subset of the geographical sites with the highest energy emissions.

7. A non-transitory computer-readable medium storing a program for energy usage management for an electrical power system, which when executed by a computer, configures the computer to:
determine an extent of local energy emission intensity of the electrical power system;
calculate a dispatching parameter for potential energy emission geographical sites;
determine a reduction in energy emission for the geographical sites over a temporal period based on the dispatching parameter; and
generate an energy emission impact report.

8. The non-transitory computer-readable medium of claim 7, wherein the energy emission is greenhouse gas or carbon emissions.

9. The non-transitory computer-readable medium of claim 7, wherein calculating the dispatching parameter comprises determining time periods in which no energy is used.

10. The non-transitory computer-readable medium of claim 7, wherein generating an energy emission impact report comprises determining an offset parameter for designated emissions.

11. The non-transitory computer-readable medium of claim 7, wherein the program, when executed by the computer, further configures the computer to change the dispatching parameter based on seasonality.

12. The non-transitory computer-readable medium of claim 7, wherein the program, when executed by the computer, further configures the computer to determine a subset of the geographical sites with the highest energy emissions.

13. A system for energy usage management for an electrical power system, comprising:
a processor; and
a non-transitory computer readable medium storing a set of instructions, which when executed by the processor, configure the processor to:
determine an extent of local energy emission intensity of the electrical power system;
calculate a dispatching parameter for potential energy emission geographical sites;
determine a reduction in energy emission for the geographical sites over a temporal period based on the dispatching parameter; and
generate an energy emission impact report.

14. The system of claim 13, wherein the energy emission is greenhouse gas or carbon emissions.

15. The system of claim 13, wherein calculating the dispatching parameter comprises determining time periods in which no energy is used.

16. The system of claim 13, wherein generating an energy emission impact report comprises determining an offset parameter for designated emissions.

17. The system of claim 13, wherein the instructions, when executed by the processor, further configure the processor to change the dispatching parameter based on seasonality.

18. The system of claim 13, wherein the instructions, when executed by the processor, further configure the processor to determine a subset of the geographical sites with the highest energy emissions.

19. The method of claim 1, further comprising performing an energy dispatching operation over the temporal period based on the determined reduction in energy emission for the geographical sites.

20. The method of claim 19, wherein the energy dispatching operation is performed using a grid intensity application programming interface.
